(19) United States
(12) Patent Application Publication
(10) Pub. No.: US 2025/0098707 A1
(43) Pub. Date: Mar. 27, 2025

(54) ANIMAL FEED INTERMEDIATE PRODUCT

(71) Applicant: NEUBURGER FLEISCHLOS GMBH, Ulrichsberg (AT)

(72) Inventor: Thomas Neuburger, Ulrichsberg (AT)

(73) Assignee: NEUBURGER FLEISCHLOS GMBH, Ulrichsberg (AT)

(21) Appl. No.: 18/895,097

(22) Filed: Sep. 24, 2024

(30) Foreign Application Priority Data
Sep. 26, 2023 (AT) GM 50147/2023

(51) Int. Cl. A23K 10/30; A23K 20/147; A23K 20/163; A23K 20/24; A23K 20/26; A23K 40/20

(52) U.S. Cl. CPC A23K 10/30; A23K 20/147; A23K 20/163; A23K 20/24; A23K 20/26; A23K 40/20

(57) ABSTRACT

The invention relates to a method for producing an animal feed intermediate product, wherein in a first step fruiting bodies of a mushroom are chopped to pieces of fruiting bodies, in a second step the pieces of fruiting bodies are mixed with other ingredients without heating, the other ingredients being added before and/or after the pieces of fruiting bodies, the pieces of fruiting bodies and the other ingredients being mixed to form a production mass, in a third step the production mass is filled into at least one mold, the production mass hardening in the mold without heating, and in a fourth step the hardened production mass is deep-frozen.

### CROSS-REFERENCE TO RELATED APPLICATIONS

The present application claims the priority of Austrian Utility Model Application No. GM 50147/2023, filed Sep. 26, 2023, entitled “ANIMAL FEED INTERMEDIATE PRODUCT”, which is incorporated by reference in its entirety.

### BACKGROUND OF THE INVENTION

### 1. Field of the Invention

The invention relates to a method for producing an animal feed intermediate product based on edible mushrooms and their fruiting bodies. The invention further relates to the products which are produced by the method.

### 2. Description of the Related Art

An animal feed intermediate product is understood to be a product that is provided by a supplier to an animal feed manufacturer for further processing.

The animal feed intermediate product in question preferably does not contain any animal meat.

The use of edible mushrooms and their fruiting bodies for the production of food is known, for example from the applicant's granted patent EP3292769B1.

### SUMMARY OF THE INVENTION

The object of the present invention is to provide an animal feed intermediate product which can be produced from tried and tested raw materials that are available in large quantities. The finished products can have a texture comparable to meat and meat products.

The animal feed intermediate product can also meet the nutritional requirements of the respective animal.

According to the invention, a method for producing an animal feed intermediate product is proposed, which is produced using the fruiting bodies of edible mushrooms as the main raw material.

The other ingredients can be selected according to the nutritional requirements of the respective animal.

The other ingredients can be selected from sodium alginate, calcium sulfate, diphosphates, calcium phosphate, vegetables, plant proteins, water.

In one embodiment, a method is proposed for producing an animal feed intermediate product, comprising at least one kind of mushroom and other ingredients that can be selected according to the requirements of the animal, whereby
in a first step, fruiting bodies of the mushroom are chopped to fruiting body pieces,
in a second step, the fruiting body pieces are mixed with the other ingredients without heating, whereby the other ingredients are added before and/or after the fruiting body pieces, whereby the fruiting body pieces and the other ingredients are mixed to form a production mass,
in a third step, the production mass is filled into at least one mold, whereby the production mass hardens in the mold without heating,
and in a fourth step, the hardened production mass is deep-frozen.

It is preferred that the mixing takes place without heating and the hardening takes place without heating at a temperature selected from a temperature range of 5° C. to 25° C.

It is preferred that
first sodium alginate, calcium sulfate, diphosphates and calcium phosphate are mixed in the mixing vessel,
then water is added and the mixture is emulsified,
then mushrooms and optionally additional vegetables are added,
then plant proteins and calcium sulfate are added,
then the mixture is filled into molds using a vacuum filler,
then the mixture is allowed to harden in the molds,
then the hardened bodies of the mixture are taken out of the molds,
then the hardened bodies are assembled and/or packaged into sales units or transport units,
then the sales units or transport units are deep-frozen.

It is preferred that said emulsification of the mixture takes place over a period of 0.5 to 8 minutes.

It is preferred that said hardening in the mold takes place over a period of at least one hour, preferably at least two hours. It is particularly preferred that said hardening in the mold takes place over a period of at least 10 hours.

It is preferred that the mushroom is a mushroom of the genus Pleurotus or Agaricus.

It is preferred that the mushroom is Pleurotus eryngii (king oyster mushroom).

The invention also relates to an animal feed intermediate product that is produced according to the process disclosed herein, which is deep-frozen and contains raw pieces of the fruiting body of a mushroom.

Preference is given to an animal feed intermediate product in which the raw fruiting body pieces have a minimum size of at least 3 mm in each spatial direction.

Preferably, the method comprises
first mixing sodium alginate, calcium sulfate, diphosphates and calcium phosphate in a mixer,
then adding water and emulsifying the mixture for at least 0.5 minutes,
then adding mushrooms and optionally additional vegetables,
then adding plant proteins and calcium sulfate,
then filling the mixture into molds using a vacuum filler,
then allowing the mixture to harden in the molds for several hours,
then taking the hardened bodies out of the molds,
then assembling and/or packaging the hardened bodies into sales units or transport units,
then freezing the sales units or transport units.

The mass is not heated in the process disclosed herein. The mushrooms are added in the form of raw pieces and remain chunky and raw during the process. The fact that the mushrooms are included as pieces means that the animal's biting and/or chewing behavior is equivalent to feeding it meat or meat products.

The other ingredients and their amounts can be chosen according to the nutritional requirements of the respective animal, drawing on the expertise of people who are familiar with the respective animal.

In a first embodiment the amounts of the following ingredients are in the following value ranges based on the total mass of the added ingredients:
sodium alginate: 1.5-4.5 wt. %
calcium sulfate: 0.5-4 wt. %
diphosphates: 0.1-2 wt. %
calcium phosphate: 0.1-3 wt. %
mushrooms: 1-60 wt. %
optional vegetables: 0 wt. % or 1-60 wt. %
plant proteins: 1-30 wt. %
water: 50-75 wt. %

In a second embodiment the amounts of the following ingredients are in the following value ranges based on the total mass of the added ingredients:
sodium alginate: 1.5-4.5 wt. %
calcium sulfate: 0.5-4 wt. %
diphosphates: 0.1-2 wt. %
calcium phosphate: 0.1-3 wt. %
mushrooms: 6-60 wt. %
optional vegetables: 0 wt. % or 6-30 wt. %
plant proteins: 6-30 wt. %
water: 50-75 wt. %

The use of fruiting bodies of edible mushrooms as a raw material is advantageous, as these represent a common and proven food and/or feed and represent a resource-saving alternative to meat or other animal products as animal feed.

The edible mushroom is preferably contained in the animal feed intermediate product produced according to the invention in a proportion of 1 to 60% by weight.

The edible mushroom is particularly preferably contained in the animal feed intermediate product produced according to the invention in a proportion of 6 to 60% by weight.

The fruiting bodies of edible mushrooms of the Pleurotus or Agaricus genus are preferably used as raw materials. The use of fruiting bodies of Pleurotus eryngii (brown oyster mushroom) as a raw material is particularly advantageous, as these mushrooms can be easily cultivated in large quantities and the flesh of the fruiting body has a rather firm consistency compared to other mushrooms.

The animal feed intermediate produced according to the process disclosed herein is advantageous because it can be produced with a compressive strength and texture comparable to meat or meat products, whereby different textures can be produced from one and the same raw material using the process according to the invention in order to be able to replicate the textures of different types of meat or types of feed preferred by the respective animal. This is done in particular by adjusting the proportion and/or size of the fruiting body pieces of the mushroom.

The density of the finished product is preferably in the range between 0.7 and 1.8 g/cm³, in particular in the range of 0.9 to 1.3 g/cm³, for example 1.1 g/cm³.

A particularly preferred method also comprises the steps:
(if necessary) preparing the mushrooms (e.g. cleaning),
chopping the mushrooms into pieces of 3 to 25 mm before adding them to the mixer.

### BRIEF DESCRIPTION OF THE DRAWINGS

The invention is illustrated by means of drawings:

FIG. 1: shows a process flow diagram of the method according to the invention.

FIG. 2: shows the method according to the invention with a schematic representation of the essential system components.

### DETAILED DESCRIPTION

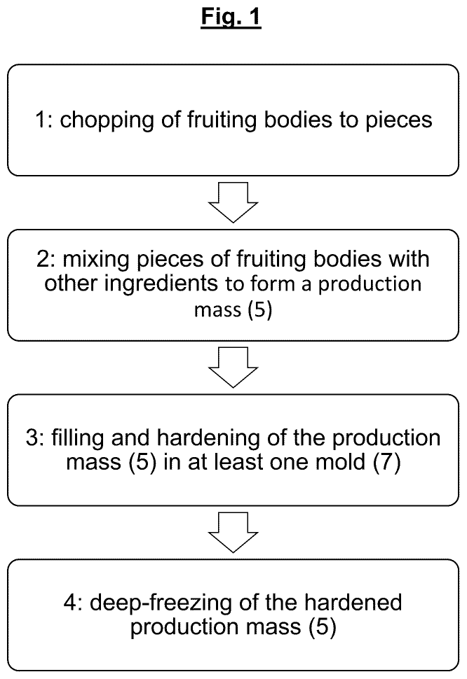

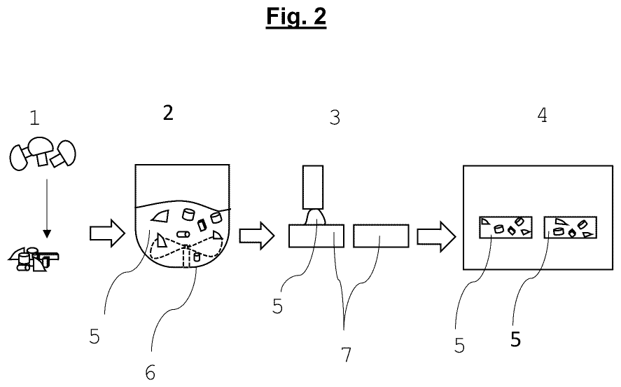

FIGS. 1 and 2 show individual process steps, whereby in a first step 1 fruiting bodies of a mushroom are chopped to pieces, in a second step 2 the fruiting bodies are mixed with other ingredients that are added to the mixer before and/or after the fruiting body pieces, in a third step 3 the production mass 5 is filled into at least one mold 7 and in a fourth step 4 the hardened production mass 5 is deep-frozen.

As illustrated in FIG. 2, in the second step 2 the production mass 5, consisting of chopped fruiting bodies and the other ingredients, is preferably homogenized with a mixer 6 for preferably 30 seconds to 8 minutes at a temperature of preferably 5 to 25° C.

The ingredients, including the mushrooms, are not shredded or chopped in the mixer. The mixer is used to mix the ingredients.

The other solid ingredients can be added in powder form.

The optionally added additional vegetables can be added in chunky form or in powder form. The optional vegetables can be selected depending on the area of application and specialist knowledge of a person familiar with the animal species.

In the third step 3, the production mass 5 is filled into at least one mold 7. A preferred mold 7 is made of plastic. The mold preferably has a capacity of 13 kg of the production mass 5. The hardened production mass 5 is preferably removed from the mold before it is deep-frozen.

In the fourth step, the hardened production mass 5 is deep-frozen, in particular by placing it in a deep-freeze room.

The method in question is preferably used to produce deep-frozen plates of the production mass 5.

1-10. (canceled)

11. A method for producing an animal feed intermediate product, the animal feed intermediate product comprising at least one kind of mushroom and other ingredients, the method comprising:
in a first step, chopping fruiting bodies of a mushroom into pieces of fruiting bodies;
in a second step, mixing the fruiting body pieces with the other ingredients without heating, the fruiting body pieces and the other ingredients being mixed to form a production mass;
in a third step, filling the production mass into at least one mold, the production mass hardening in the mold without heating; and
in a fourth step, deep-freezing the hardened production mass.

12. The method according to claim 11, wherein the second step and the third step are performed at a temperature in a range of 5° C. to 25° C.

13. The method according to claim 11, further comprising:
first mixing mixing vessel sodium alginate, calcium sulfate, diphosphates and calcium phosphate;
then adding water and the mixture is emulsified;
then mixing in the mushrooms;
then plant proteins and calcium sulfate are mixed in;
then the mixture is filled into molds using a vacuum filler;
then the mixture is allowed to harden in the molds;
then the hardened bodies of the mixture are turned out of the molds;
then the hardened bodies are at least one of assembled into sales units, assembled into transport units, and packaged; and
then the sales or transport units are deep-frozen.

14. The method according to claim 13, further comprising mixing in additional vegetables when mixing in the mushrooms.

15. The method according to claim 13, wherein the emulsification takes place over a period of 0.5 to 8 minutes.

16. The method according to claim 11, wherein the hardening in the mold takes place over a period of at least one hour.

17. The method according to claim 16, wherein the hardening in the mold takes place over a period of at least ten hours.

18. The method according to claim 11, wherein the fruiting body pieces are in a form of pieces with a minimum extension of at least 3 mm and a maximum extension of a maximum of 25 mm.

19. The method according to claim 11, wherein the mushroom is a mushroom of the genus Pleurotus or Agaricus.

20. The method according to claim 11, wherein the mushroom is Pleurotus eryngii (king oyster mushroom).

21. An animal feed intermediate product produced by a method, the animal feed intermediate product comprising at least one kind of mushroom and other ingredients, the method comprising:
in a first step, chopping fruiting bodies of a mushroom into pieces of fruiting bodies;
in a second step, mixing the fruiting body pieces with the other ingredients without heating, the fruiting body pieces and the other ingredients being mixed to form a production mass;
in a third step, filling the production mass into at least one mold, the production mass hardening in the mold without heating; and
in a fourth step, deep-freezing the hardened production mass;
wherein the animal feed intermediate product is deep-frozen and contains raw fruiting body pieces of a mushroom.

22. The animal feed intermediate product according to claim 21, wherein the raw fruiting body pieces have a minimum size of at least 3 mm in every spatial direction.
